(19) United States
(12) Patent Application Publication
(10) Pub. No.: US 2025/0383211 A1
(43) Pub. Date: Dec. 18, 2025

(54) ROUTE PLANNING BASED ON ROAD CONDITIONS AND ROAD TREATMENTS

(71) Applicant: GM Global Technology Operations LLC, Detroit, MI (US)

(72) Inventors: Alec M. Wuorinen, Columbus, OH (US); Matthew Edward Gilbert-Eyres, Rochester Hills, MI (US); Craig Thomas Douglas, Pflugerville, TX (US); Adam Miller Sparling, Grosse Pointe Farms, MI (US); Russell A. Patenaude, Macomb Township, MI (US)

(21) Appl. No.: 18/746,859

(22) Filed: Jun. 18, 2024

(51) Int. Cl. G01C 21/34; B60W 60/00; G01C 21/36

(52) U.S. Cl. CPC G01C 21/3461; B60W 60/001; G01C 21/3492; G01C 21/3691

(57) ABSTRACT

A system for planning a route for a vehicle includes a route planning module configured to receive a destination, the route planning module configured to detect that a road network in a geographic region is subject to a hazardous event that causes a hazardous condition in the road network, identify a subset of the road network that has been treated or will be treated within a selected time window to remediate the hazardous condition, and calculate a planned route for the vehicle to follow based on the destination and the identified subset of the road network. The system also includes a second module configured to perform at least one of controlling the vehicle to follow the planned route, and presenting the planned route to a vehicle user.

### INTRODUCTION

The subject disclosure relates to vehicle route planning, and more particularly to planning vehicle routes in hazardous conditions.

Vehicles (e.g., automobiles, trucks, construction equipment, farm equipment, automated factory equipment, etc.) increasingly rely on digital maps and route planning systems for navigation. For example, navigation systems commonly utilize map applications (e.g., mobile applications and/or on-board navigation systems) to select routes for travel. Such routes may be presented to drivers and/or may be used for autonomous and semi-autonomous operation (e.g., collision avoidance, adaptive cruise control, automatic braking, etc.). In some cases, conditions that affect navigation can change rapidly, for example, due to changes in weather conditions and associated road conditions.

### SUMMARY

In one exemplary embodiment, system for planning a route for a vehicle includes a route planning module configured to receive a destination, the route planning module configured to detect that a road network in a geographic region is subject to a hazardous event that causes a hazardous condition in the road network, identify a subset of the road network that has been treated or will be treated within a selected time window to remediate the hazardous condition, and calculate a planned route for the vehicle to follow based on the destination and the identified subset of the road network. The system also includes a second module configured to perform at least one of controlling the vehicle to follow the planned route, and presenting the planned route to a vehicle user.

In addition to one or more of the features described herein, the subset of the road network is identified based on tracking data indicative of a position and movement of road treatment vehicles in the geographic region.

In addition to one or more of the features described herein, the subset of the road network is identified based on an evaluation of current weather conditions and historical data related to past road treatments.

In addition to one or more of the features described herein, the planned route terminates at the destination.

In addition to one or more of the features described herein, calculating the planned route includes updating an initial route determined for the vehicle, the initial route terminating at an initial planned destination.

In addition to one or more of the features described herein, updating the initial route includes selecting a new destination based on determining that the initial planned destination is not feasible given a capability of the vehicle.

In addition to one or more of the features described herein, calculating the planned route is based on a capability of the vehicle to travel on a road segment having the hazardous condition.

In addition to one or more of the features described herein, the vehicle is a road treatment vehicle, and the planned route is calculated to cause the road treatment vehicle to follow a treatment path based on a traffic flow of one or more other vehicles in the geographic region.

In addition to one or more of the features described herein, the planned route is calculated based on a destination and vehicle type associated with each of a plurality of other vehicles traversing the road network.

In another exemplary embodiment, a method of planning a route for a vehicle includes receiving a destination, detecting that a road network in a geographic region is subject to a hazardous event that causes a hazardous condition in the road network, identifying a subset of the road network that has been treated or will be treated within a selected time window to remediate the hazardous condition, and calculating a planned route for the vehicle to follow based on the destination and the identified subset of the road network. The method also includes performing at least one of controlling the vehicle to follow the planned route, and presenting the planned route to a vehicle user.

In addition to one or more of the features described herein, the subset of the road network is identified based on tracking data indicative of a position and movement of road treatment vehicles in the geographic region.

In addition to one or more of the features described herein, the subset of the road network is identified based on an evaluation of current weather conditions and historical data related to past road treatments.

In addition to one or more of the features described herein, calculating the planned route includes updating an initial route determined for the vehicle, the initial route terminating at an initial planned destination or terminating at a new destination based on determining that the initial planned destination is not feasible given a capability of the vehicle.

In addition to one or more of the features described herein, calculating the planned route is based on a capability of the vehicle to travel on road segments having the hazardous condition.

In addition to one or more of the features described herein, the vehicle is a road treatment vehicle, and the planned route is calculated to cause the road treatment vehicle to follow a treatment path based on a traffic flow of one or more other vehicles in the geographic region.

In yet another exemplary embodiment, a vehicle system includes a memory having computer readable instructions, and a processing device for executing the computer readable instructions, the computer readable instructions controlling the processing device to perform a method. The method includes receiving a destination and a request to determine a route to the destination for a vehicle to traverse, detecting that a road network in a geographic region is subject to a hazardous event that causes a hazardous condition in the road network, identifying a subset of the road network that has been treated or will be treated within a selected time window to remediate the hazardous condition, calculating a planned route for the vehicle to follow based on the destination and the identified subset of the road network, and performing at least one of controlling the vehicle to follow the planned route, and presenting the planned route to a vehicle user.

In addition to one or more of the features described herein, the subset of the road network is identified based on tracking data indicative of a position and movement of road treatment vehicles in the geographic region.

In addition to one or more of the features described herein, the subset of the road network is identified based on an evaluation of current weather conditions and historical data related to past road treatments.

In addition to one or more of the features described herein, calculating the planned route includes updating an initial route determined for the vehicle, the initial route terminating at an initial planned destination or terminating at a new destination based on determining that the initial planned destination is not feasible given a capability of the vehicle, and wherein calculating the planned route is based on a capability of the vehicle to travel on a road segment having the hazardous condition.

In addition to one or more of the features described herein, the vehicle is a road treatment vehicle, and the planned route is calculated to cause the road treatment vehicle to follow a treatment path based on a traffic flow of one or more other vehicles in the geographic region.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle, in accordance with an exemplary embodiment;

FIG. 2 is a flow diagram representing a method of planning a vehicle route, in accordance with an exemplary embodiment;

FIG. 3 is a flow diagram representing a method of planning a vehicle route based on road conditions and road treatment information, and/or controlling aspects of road treatments, in accordance with an exemplary embodiment;

FIG. 4 is a flow diagram representing a method of calculating a score for a planned route for a vehicle, in accordance with an exemplary embodiment;

FIG. 5 is a flow diagram representing a method of planning a vehicle route, in accordance with an exemplary embodiment;

FIG. 6 is a flow diagram representing a method of scheduling a time for traversing a planned vehicle route, in accordance with an exemplary embodiment;

FIG. 7 depicts an example of a road network, and aspects of planning a route for a vehicle;

FIG. 8 depicts an example of a road network, and aspects of planning a route for a vehicle based on vehicle capability;

FIG. 9 depicts an example of a road network, and aspects of planning a route for a passenger vehicle and a route for a road treatment vehicle;

FIG. 10 depicts an example of a road network, and aspects of planning a route for a passenger vehicle and a route for a road treatment vehicle; and

FIG. 11 depicts a computer system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Devices, systems and methods are provided for vehicle route planning and/or vehicle control. An embodiment of a planning system is configured to calculate a route for a vehicle to follow based on a desired destination, road conditions and road treatments. The route is calculated based on road treatment information, including locations and routes of treatment vehicles (e.g., snowplows), such that the route is optimized (e.g., the vehicle is directed to road segments that are or have been recently treated).

In an embodiment, the planning system receives an initial route for travelling in a road network, determines the treatment state of road segments therein (i.e., whether and how recently a road segment has been treated) and updates the initial route if desired to avoid segments that are not within a vehicle's capability. The updated route may be a route that terminates at the desired destination, or may be a route to an alternate destination. In an embodiment, the planning system is configured to provide vehicle information for use in improving or optimizing routes of road treatment vehicles. Embodiments also include systems and methods for optimizing routes for road treatment vehicles.

Embodiments described herein present numerous advantages and technical effects. For example, embodiments provide for effective planning methods that account for road treatments, so that a vehicle can avoid traveling in conditions unsuitable for a given vehicle type and capabilities. Embodiments also provide for improvements in road treatments by optimizing routes of road treatment vehicles.

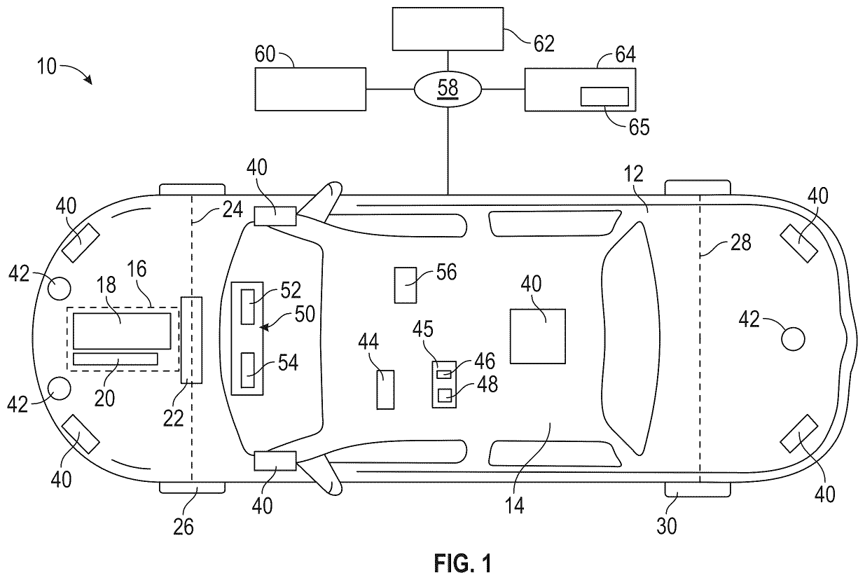

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor 20. The vehicle 10 may be a fully electric vehicle having one or more electric motors.

The propulsion system 16 includes various other components, such as a transmission system 22 for applying torque to a front drive shaft 24 connected to front wheels 26. The propulsion system 16 is not so limited. For example, the propulsion system 16 may include components (e.g., transmission, the motor 20 and/or an additional motor) for driving a rear drive shaft 28 connected to rear wheels 30.

The vehicle 10 also includes a monitoring system, route planning system and/or a vehicle control system, aspects of which may be incorporated in or connected to the vehicle 10. The monitoring system in this embodiment includes one or more optical cameras 40 configured to take images, which may be still images and/or video images. Additional devices or sensors may be included, such as one or more radar assemblies 42 included in the vehicle 10. The monitoring system is not so limited and may include other types of sensors, such as lidar and infrared.

Control devices and actuators, and other components such as the monitoring system, are controllable via one or more control units, collectively represented by a vehicle controller 44. The vehicle controller 44 includes processing components for controlling aspects of vehicle operation, such as control of propulsion, braking and steering, as well as functions such as monitoring and path planning.

The vehicle controller 44 may be configured to control the vehicle 10 in accordance with various forms of automated control. In an embodiment, the vehicle controller 44 is configured for one or more automation levels. For example, the vehicle 10 is controllable via Level 1, Level 2 and/or Level 3 automation. Level 1 automation includes driver assistance. Level 2 automation allows for vehicle control of steering and acceleration, with the driver monitoring and ready to take control at any time. In Level 3 automation (conditional automation), a vehicle can monitor the environment and automatically control the operation.

The vehicle also includes a navigation or route planning system 45 configured to plan routes for vehicle travel to selected destinations, and configured to provide for alternate route planning due to hazardous conditions. The route planning system 45 is also configured to account for road treatment operations, such as snow plowing and road surface salting, and provide for route planning based on the status of road treatments and position and routes of road treatment vehicles, such as snowplows.

The route planning system 45 includes one or more processors or modules, such as a planning module 46 for determining routes as described herein, and a suggestion module 48 for providing information and/or route suggestions to a user (e.g., a driver of a passenger vehicle and/or a road treatment vehicle). If autonomous control is employed, the planning module 46 may communication with the vehicle controller 44 for controlling vehicle movement based on planned and/or adjusted routes as described herein.

The vehicle 10, monitoring system, the vehicle controller 44, the planning module 46 and other vehicle systems are included in, or are connected to, an on-board computer system 50 that includes one or more processing devices 52 and a user interface 54. The user interface 54 may include a touchscreen, a speech recognition system and/or various buttons for allowing a user to interact with features of the vehicle. The user interface 54 may be configured to interact with a user or driver via visual communications (e.g., text and/or graphical displays), tactile communications or alerts (e.g., vibration), and/or audible communications.

An embodiment of the vehicle 10 includes devices and/or systems for communicating with other vehicles and/or objects external to the vehicle. For example, the vehicle 10 includes a communication system having a telematics unit 56 or other suitable device including an antenna or other transmitter/receiver for communicating with a network 58. The network 58 represents any one or a combination of different types of suitable communications networks, such as public networks (e.g., the Internet), private networks, wireless networks, cellular networks, or any other suitable private and/or public networks.

The network 58 connects the vehicle 10 for communication with various entities. For example, the network 58 may be connected to a server 60, databases 62 and/or other remote entities 64 such as workstations, control centers, fleet centers (e.g., for road maintenance fleet monitoring) other vehicles and others. The network 58 allows the vehicle 10 to acquire information for use in planning and route determination, such as weather information, fleet information, map data, traffic information, and others.

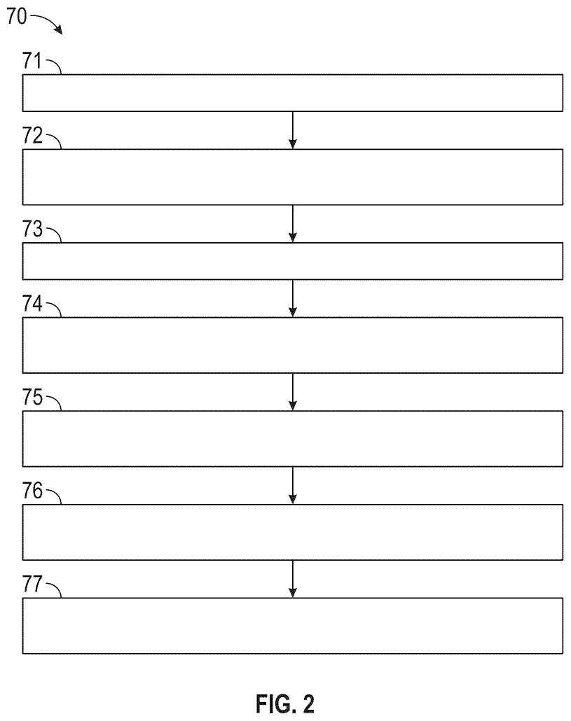

FIG. 2 depicts an embodiment of a method 70 of determining a route for a vehicle based on road conditions and road treatments. The method 70 is discussed in conjunction with blocks 71-77. The method 70 is not limited to the number or order of steps therein, as some steps represented by blocks 71-77 may be performed in a different order than that described below, or fewer than all of the steps may be performed. The method 70 is discussed in conjunction with the vehicle 10 of FIG. 1 and a processing system, which may be, for example, the computer system 50, the planning system 45, or a combination thereof.

The method 70 is described as being performed by the planning system 45. It is noted that the methods are not so limited and may be performed by any suitable processing device or system, or combination of processing devices.

At block 71, the planning system 45 receives a destination for the vehicle 10 to travel to within a geographic region.

At block 72, the planning module 46 collects information for route planning, such as map data, and calculates an initial route for traversing a road network in the geographic region. The planning module 46 also collects information regarding the vehicle's capability (i.e., ability to traverse different road types and conditions). For example, data such as vehicle type (e.g., sedan, sport utility vehicle (SUV), truck, commercial vehicle, etc.), vehicle condition (e.g., age), vehicle features (e.g., snow tires, chains) and others is collected. This data may be used to determine vehicle limitations with respect to various road conditions.

At block 73, the planning module 46 calculates an initial route for the vehicle 10 to travel to reach the desired destination. For example, map data is accessed and the planning module 46 calculates an initial route based on the map data, as well as other information, such as desired time of departure and/or arrival, traffic conditions, and others.

At block 74, the planning module 46 determines whether any geographic regions (regions through which the planned route is expected to enter or pass through) are subject to an event or events that may cause hazardous conditions. In an embodiment, the event is a winter weather event (e.g., snow, sleet, etc.) that can cause roads in the region to be subject to a hazardous condition (e.g., snowy, icy, slippery, etc.). Such events are referred to herein as “hazardous events.” This determination may be based on any suitable information, such as weather reports, news reports, monitoring data from the vehicle (e.g., images from camera and/or lidar assemblies), notifications from mapping applications, notifications from other vehicles and/or fleet control centers, and others.

At block 75, based on determining that a hazardous event has occurred or is occurring, the planning module 46 identifies which (if any) roads or road segments have been treated or are in the process of being treated. Road segments are described herein as being treated by a snowplow or other public works vehicle, or any other vehicle that is configured to apply a road treatment (referred to herein as a “road treatment vehicle”). A “road treatment” is any action or application applied to a road or road surface to mitigate an undesirable or hazardous condition, such as snow, ice, and others. Examples of road treatments include snow plowing, salting, applying sand and others.

Roads and road segments in the road network that have been treated (e.g., within a selected time relative to a current time) or are scheduled to be treated are referred to as a “subset” of the road network. The subset may include a single road or road segment, or multiple roads or road segments.

For example, if the hazardous event is a winter weather event, the planning module 46 accesses fleet data from monitoring snowplow treatments in the geographic area. The fleet data indicates, for example, the current location of snowplows, the previous and expected paths of the snowplows, which roads have been treated, how long since a given road has been treated, and others.

At block 76, the planning module 46 re-calculates or updates the initial route based on the fleet data and/or other information regarding the status of road treatments, to generate a final planned route. The final planned route may take into account vehicle capability. “Capability” refers to the ability to effectively traverse a given road condition or severity of a given road condition (e.g., snow depth). Vehicles with four wheel drive, trucks, vehicles with chains and other vehicles can be assessed to have a relatively high capability, as they are able to traverse road segments that other vehicles are not considered to be able to traverse (e.g., sedans have a relatively low capability).

For example, if the vehicle is a sedan, road segments that have not been treated, or have not been treated sufficiently recently, are not considered available. In contrast, there may be additional road segments available for vehicles with tire chains or winter tires.

The initial route is updated so that the vehicle 10 follows treated road segments, and/or road segments that the vehicle is capable of handling. The initial route may be adjusted so that the final planned route reaches the destination. In other instances, such as when the planning module 46 cannot identify a suitable route to the destination, the planning module 46 may suggest an alternate destination and/or present one or more routes to one or more alternate destinations.

At block 77, a suitable action is performed so that the vehicle 10 follows the final planned route. For example, the suggestion module 48 may present the initial route and the final planned route for a user to follow (or approve if autonomous control is used). In another example, the vehicle 10 is autonomously controlled over at least a portion of the final planned route.

In an embodiment, a system is provided for planning and controlling routes of road treatment vehicles. A route planning module or other processing device in a road treatment vehicle (e.g., a snowplow and/or salt spreader), or in an entity such as a control center, is configured to receive information regarding the presence or expected presence of vehicles in a road network being treated. For example, referring again to FIG. 1, the remote entity 64 may be a control center 64, and include a route planning module 65 for planning and coordinating routes of road treatment vehicles.

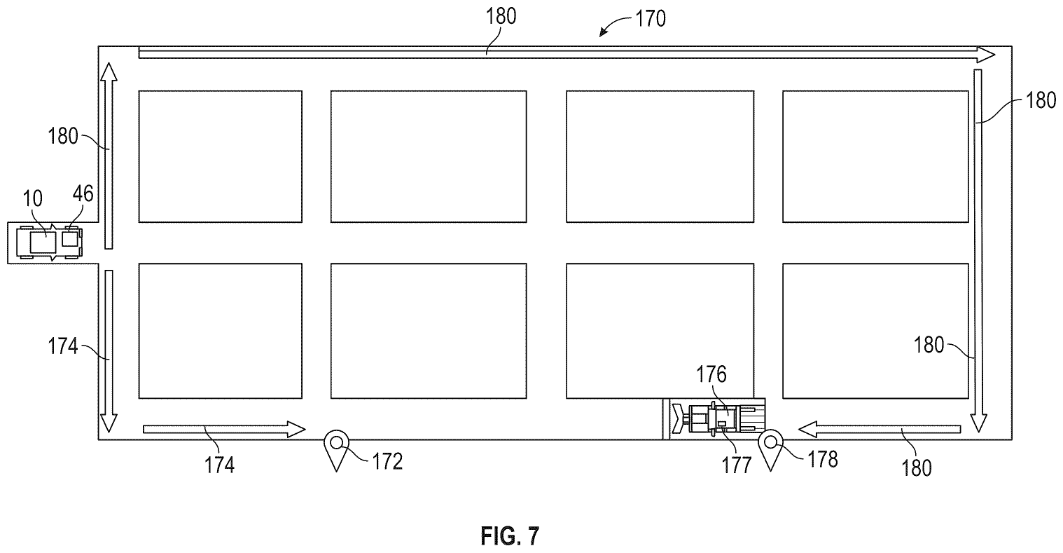

Information used for road treatment vehicle planning includes, for example, the location and planned routes for one or more other vehicles, and the capability of each other vehicle to handle hazardous conditions. A road treatment vehicle (e.g., a road treatment vehicle 176, FIG. 7) receives this information by communicating with the other vehicles or with another entity, such as the control center 64. Based on this information, a route planning module 177 in the road treatment vehicle 176 may plan or update a planned route to facilitate movement of vehicles. For example, the road treatment vehicle can prioritize road segments expected to have the highest number of vehicles, or vehicles with lower capabilities.

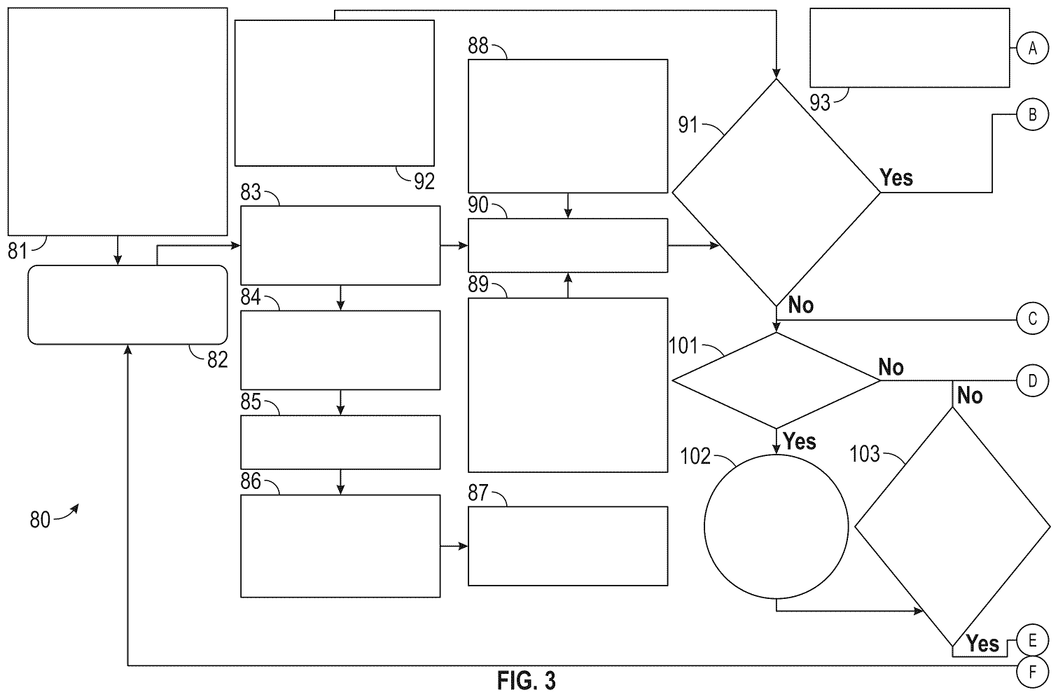

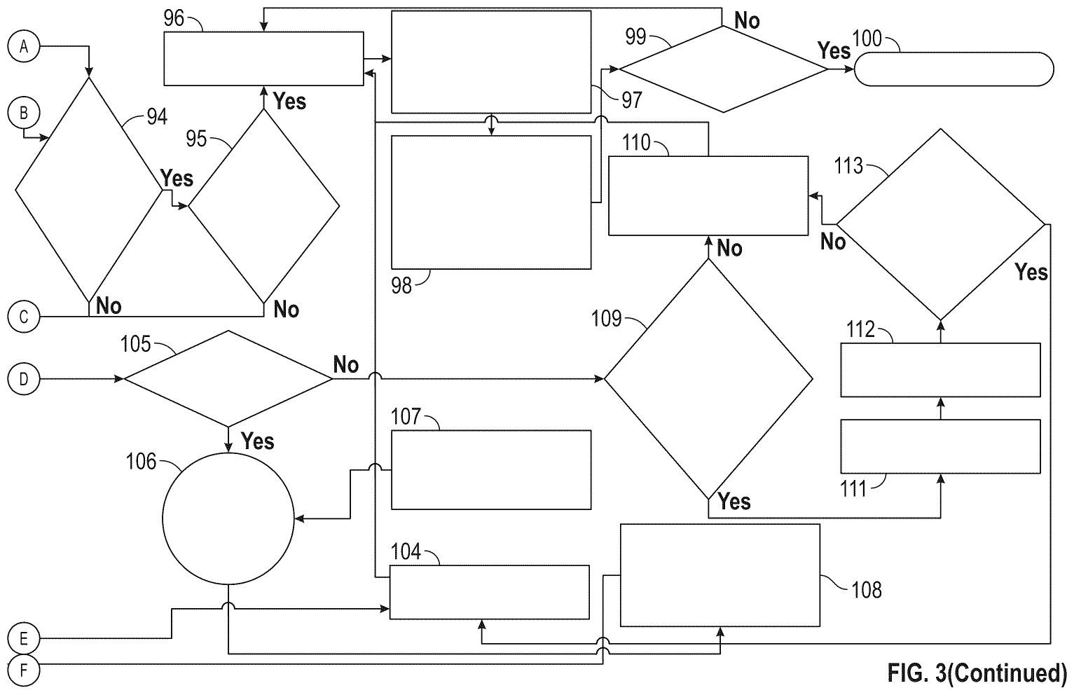

FIG. 3 depicts an embodiment of a method 80 of determining a route for a vehicle based on road conditions and road treatments. The method 80 is discussed in conjunction with blocks 81-113. The method 80 is not limited to the number or order of steps therein, as some steps represented by blocks 81-113 may be performed in a different order than that described below, or fewer than all of the steps may be performed. For example, the method 80 may include route planning for a vehicle, route planning for road treatment vehicles, or both.

The method 80 is discussed in conjunction with an example in which the road treatment vehicles are snowplows, for illustrative purposes. In this example, a final planned route is determined that allows a driver to remain on plowed roads to a maximum extent available.

Aspects of the method 80 are described as being performed by the planning system 45 of the vehicle 10 (FIG. 1). Other aspects of the method are described as being performed by a road treatment vehicle and/or the control center 64 (FIG. 1). The method 80 is not so limited, and can be performed by any suitable processing device or combination of processing devices.

At block 81, a destination is received by the planning module 46, and the planning module 46 collects relevant data regarding the vehicle 10. Examples of such data include the vehicle's current location, data related to capability of the vehicle 10, and time constraints (e.g., preferred departure and arrival times, and acceptable deviations therefrom). In an embodiment, a reason for travel to the destination is determined, which can allow the planning module 46 to determine an alternative destination if appropriate (e.g., if a suitable route to the initial destination is not found).

Vehicle capability, in an embodiment, is determined by collecting information relevant to performance of the vehicle 10 in a hazardous condition. Such information may include vehicle make and model, age, vehicle features (e.g., traction control, antilock braking, tire chains, etc.) and other characteristics.

Specific vehicle attributes at the time of travel may be used to determine capability. For example, the planning module 46 may consider vehicle weight attributes due to a number of passengers, added sandbags, an amount of fuel and others. The information may be analyzed to create a model of performance specific to the vehicle 10.

At block 82, the planning module 46 calculates an initial route for the vehicle 10. The initial route is calculated using relevant data, which includes map data or other data representing a road network.

At block 83, the vehicle's initial location and the destination are transmitted to the control center 64 for analysis in order to guide road treatment vehicles in a geographical region subject to hazardous conditions (e.g., snow, ice, etc.).

At block 84, the vehicle 10 location and destination are combined with available routing data for other vehicles in the geographic region (or expected to be in the geographic region). From this information, routing and traffic trends are calculated. Such trends may be transmitted to road treatment vehicles in the field (block 85), and the routes of one or more individual road treatment vehicles are updated as desired to provide for efficient treatment coverage (block 86).

For example, road segments and routes determined to be busier (i.e., have more vehicles traveling thereon) may be prioritized. In another example, the capabilities and/or vehicle types associated with the other vehicles are accounted for when updating road treatment routes (block 87).

At block 88, data indicative of conditions of the geographic region are collected. In an embodiment, current and/or historical weather data (e.g., previous 24 hours, seasonal information, etc.) is collected, which may include current weather conditions and/or forecasts.

At block 89, data indicative of road treatments applied (and scheduled to be applied) to roads in the road network is collected. Such data may be indicative of the positions and routes of road treatment vehicles such as snowplows. For example, plow location data, including current and previous location data, is collected. This data is used to identify a subset of the road network (i.e., one or more road segments) that are currently being treated, or are scheduled to be treated.

Conditions of road segments, such as snow depth, may be determined based on the locations and routes of road treatment vehicles. For example, the locations and routes are evaluated in combination with weather information (e.g., rate of snow accumulation) to calculate snow depth based on how much time has elapsed since a road segment was last plowed.

At block 90, a score (“route score”) is calculated for the initial route. The route score is calculated, in an embodiment, by correlating road conditions with a numerical value. The route score may be calculated based on a condition of each road segment along the initial route, which may be determined using tracking data indicative of a position and movement of road treatment vehicles in the geographic region. For example, the route score for a given road segment is calculated based on weather information and an amount of time that has elapsed since the segment was last treated. The route score is also based on the capability of the vehicle 10 to operate effectively in the condition of the road segment.

At block 91, the planning module 46 determines whether the initial route is suitable for traversal, given the current and expected state of road treatments. For example, the route score is compared to a threshold value. In an embodiment, crowdsourced data related to comparable vehicles, and the performance of the comparable vehicles in similar conditions, is used to determine whether the initial route is suitable (block 92).

At block 93, if the initial route is determined to be suitable (e.g., the route score exceeds a threshold value), the planning module 46 acquires weather information (e.g., forecasts). At block 94, it is determined whether conditions permit the vehicle 10 to travel the entirety of the initial route.

At block 95, if the conditions permit the vehicle 10 to travel the entirety of the route, it is determined whether the vehicle 10 will be able to reach the destination within a desired time window. If so, at block 96, the vehicle 10 travels according to the initial route, and monitoring is performed (block 97) to assess the current conditions and performance of the vehicle 10. For example, conditions of a road segment, such as snow depth, are continuously or periodically determined in the vicinity of the vehicle 10. Snow depth (or other condition) may be determined by using monitoring or imaging data to measure snow depth or otherwise characterize the road condition, or determined based on an amount of time since a snowplow plowed the current road segment.

Vehicle performance is also monitored, such as speed, slippage (i.e., instances of swerving, tire spinning, etc.), driver condition (e.g., driver fatigue or alertness based on information from a driver monitoring system), fuel and/or battery power usage, and other relevant behaviors.

At block 97, performance information is used to update data describing vehicle capability. For example, a vehicle model may be initially used to assess vehicle capability, and the vehicle model is updated at block 98.

At block 99, the vehicle location is monitored and compared to the destination. If the destination is not yet reached, the vehicle 10 continues to be monitored (blocks 96-98) until the destination is reached (block 100).

At block 101, if the initial route is not determined to be suitable at block 95 (e.g., the route score is less than or equal to the threshold), the planning module 46 determines whether other routes are available.

At block 102, if alternatives are available, the planning module 46 calculates at least one updated route based on the state of road treatments.

At block 103, the planning module 46 evaluates each updated route that satisfies a desired time frame and exceeds the route score threshold. For example, the planning module determines whether there is any updated route that satisfies the desired time window and has a route score that exceeds the route score threshold.

At block 104, if at least one updated route satisfies time and score thresholds, one of the routes is selected as the final planned route. The final planned route may be presented to a vehicle driver via the suggestion module 48 and an interface (e.g., the computer system interface 54, FIG. 1). Alternatively, if autonomous control is enabled, the planning module 46 may instruct a vehicle control system (e.g., the vehicle controller 44) to operate the vehicle 10 to traverse the final planned route. If the vehicle 10 is operated to traverse the final planned route, the method 80 proceeds to block 96.

At block 105, if alternative routes are not available (as determined at block 101), or if none of the alternative routes are suitable (as determined at block 103), the planning module 46 determines whether the arrival time is flexible. This may be determined when collecting data at block 81, or the driver may be queried.

At block 106, if the arrival time is flexible, the planning module 46 calculates an alternate departure time. For example, weather forecasts (block 107) are used to determine when the weather will become more conducive to travel, and the suggestion module 48 notifies the driver that the driver should delay, and may offer suggestions for alternative departure times (block 108).

At block 109, if the arrival time is not flexible, the planning module 46 determines whether the destination is flexible. This determination may be made based on information acquired at block 81. For example, the driver may indicate whether the destination is flexible, or the planning module may infer wither the destination is flexible based on the type of destination or reason for travel (e.g., travel for groceries or gas is considered flexible, whereas specific destinations such as day care are not).

If the destination is not flexible, the suggestion module 48 many notifier the driver, at block 110, that a suitable route was not found, and recommend other actions (e.g., delay the trip, take extreme caution, etc.).

At block 111, if the destination is flexible, the planning module 46 identifies alternative locations (e.g., other grocery stores). One or more alternate routes are identified and evaluated by calculating a route score for each and comparing each to a score threshold (block 112), and by determining at block 113 whether each route satisfies time requirements (e.g., is within some range of the desired arrival time).

If an alternative route is found to be suitable, the alternative route is presented to the driver at block 104 (or the vehicle 10 is autonomously controlled according to the alternate route). If no alternative route to an alternative destination is found to be suitable, the method 80 proceeds to block 110, where the driver is notified and other actions may be recommended.

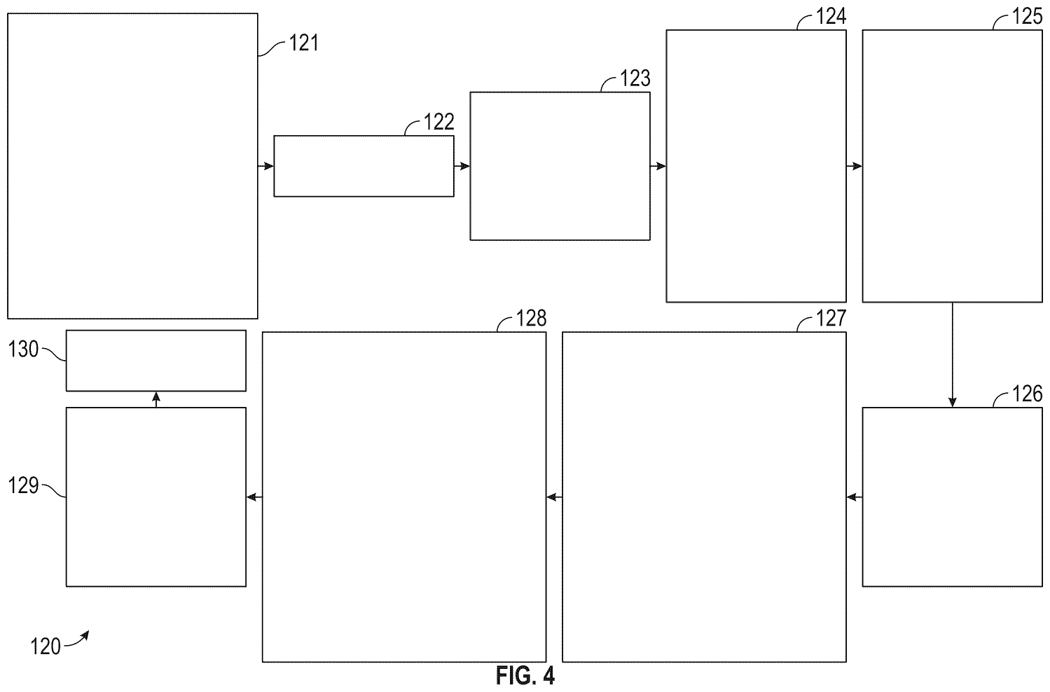

FIG. 4 depicts an example of a method 120 of calculating a route score. The method 120 is discussed in conjunction with blocks 121-130. The method 120 is not limited to the number or order of steps therein, as some steps represented by blocks 121-130 may be performed in a different order than that described below, or fewer than all of the steps may be performed. The method 120 is discussed in conjunction with an example in which the road treatment vehicles are snowplows, for illustrative purposes. However, the method 120 is not so limited and is applicable to any type of hazardous condition (e.g., ice, wind, etc.).

In this example, a number of different factors are considered, and an initial score is revised for each factor. The method 120 is not limited to the specific number or type of factors considered.

At block 121, weather data (current and forecasted weather), location data for road treatment vehicles, vehicle data (for capability determination), route information, traffic information and/or other available data is collected.

At block 122, for a given route (e.g., an initial route or an alternative route), an initial or default route score is assigned to the route. The default score is, for example, 100.

At block 123, if a weather alert is received, or the planning module 46 otherwise determines that a hazardous condition is present or forecasted, a selected value (e.g., 20) is subtracted from the default score.

At block 124, a baseline snow score is calculated and subtracted. For example, the baseline snow score is calculated as a number of inches of snow since the last time the temperature was above freezing, multiplied by a selected number (e.g., 5). The baseline snow score is then subtracted from the score calculated at block 123.

At block 125, a future snow score is calculated and subtracted. For example, the future snow score is calculated as a number of inches of snow forecasted to fall over the course of a planned trip, multiplied by a selected number (e.g., 10). The future snow score is then subtracted from the score calculated at block 124.

At block 126, a route distance score is calculated (e.g., number of miles multiplied by, e.g., 2) and subtracted from the score calculated at block 125.

At block 127, a score is calculated based on the number of sections of a road network that have been plowed (or plowed within some time window). For example, a segment score is calculated for each segment as:

Segment score=distance plowed/total route distance/time, (1)

where “total route distance” is the total distance associated with the route for the vehicle 10. “time” in equation (1) refers to an amount of time (e.g., number of hours) elapsed between the last time the segment was plowed, and a time at which the vehicle 10 is expected to reach the segment.

A total score is calculated by summing all of the segment scores, and the total score is subtracted from the score that was calculated at block 126.

Similarly, at block 128, a score is calculated based on the number of sections of a road network that will be plowed (prior to the vehicle 10 arriving) according to the planned route(s) of road treatment vehicles. For example, a segment score is calculated for each segment as:

Segment score=distance expected to be plowed/total route distance/time, (2)

where “distance expected to be plowed” is the total distance that is expected to be plowed when the vehicle 10 reaches the segment. A total score is calculated by summing all of the segment scores, and the total score is subtracted from the score calculated at block 127.

At block 129, the route score is further based on the capability of the vehicle 10. The score calculated at block 128 may be multiplied by a factor corresponding to the capability of the vehicle 10. For example, for a vehicle having a higher capability, such as a truck, the score is multiplied by a relatively high factor (e.g., 1.5). In contrast, for a vehicle having a lower capability (e.g., sedan), a relatively low factor (e.g., 1) is used.

Once the route score is finalized, at block 130, the route score is used to evaluate the route as discussed above.

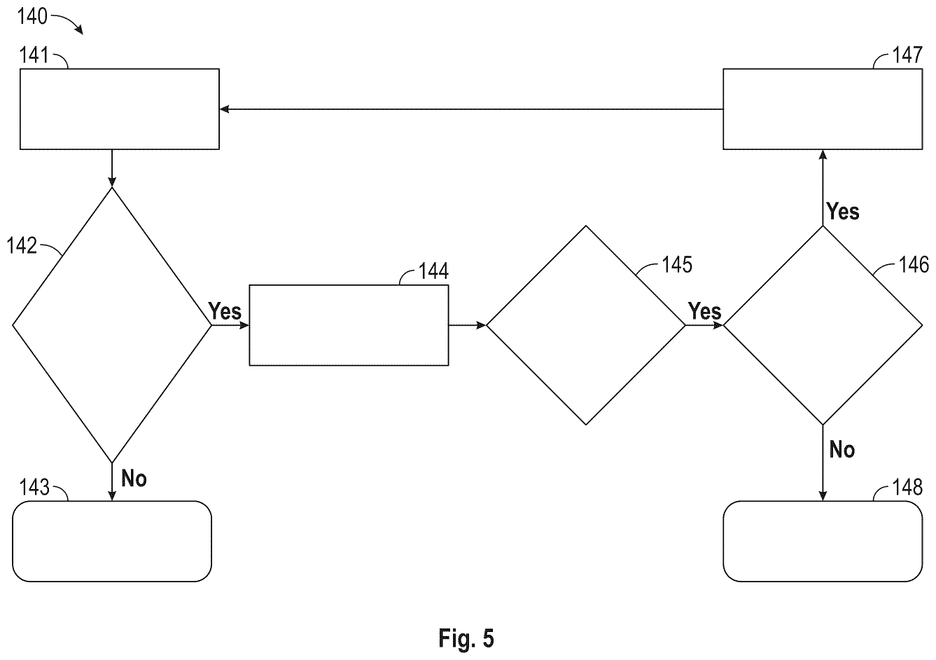

FIG. 5 depicts an embodiment of a method 140 of calculating an alternate route. The method 140 is discussed in conjunction with blocks 141-148. The method 140 is not limited to the number or order of steps therein, as some steps represented by blocks 141-148 may be performed in a different order than that described below, or fewer than all of the steps may be performed. The method 140 is discussed in conjunction with an example in which the road treatment vehicles are snowplows, for illustrative purposes. However, the method 140 is not so limited and is applicable to any type of hazardous condition (e.g., ice, wind, etc.).

The method 140 is described as being performed by the planning system 45 of the vehicle 10 (FIG. 1). The method 140 is not so limited, and can be performed by any suitable processing device or combination of processing devices.

At block 141, an alternative route is selected, a first route score for the selected alternative route is calculated as discussed herein, and time constraints are determined. Time constraints are determined based on the desired departure and arrival times, and an extent of flexibility of the desired departure time and/or arrival time.

At block 142, the planning module 46 determines whether there are one or more additional alternative routes that satisfy route score and time constraints. If no suitable additional alternative routes are available, the selected alternative route is presented to the driver at block 143.

At block 144, if a second alternative route is available, a second route score for the second alternative route is calculated. At block 145, it is determined whether the second route score is higher than the first route score.

At block 146, if the second route score is higher, the planning module 46 determines whether there are any further alternative routes available that haven't yet been scored and compared. If so, the second route score is fed back to block 141 and another available route is evaluated (block 147). If there are no other available alternative routes, the second alternative route is presented to the driver (block 148).

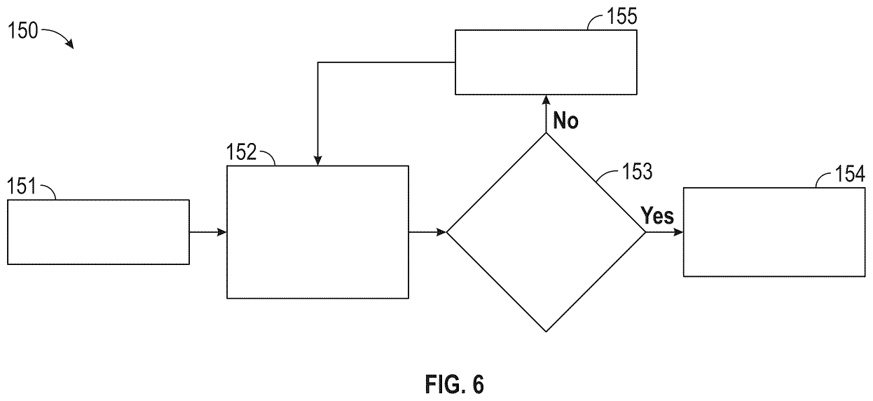

FIG. 6 depicts an embodiment of a method 150 of calculating an alternate an alternate departure time. The method 150 may be performed as block 105 of the method 80.

The method 150 is discussed in conjunction with blocks 151-155. The method 150 is not limited to the number or order of steps therein, as some steps represented by blocks 151-155 may be performed in a different order than that described below, or fewer than all of the steps may be performed.

The method 150 is described as being performed by the planning system 45 of the vehicle 10 (FIG. 1). The method 150 is not so limited, and can be performed by any suitable processing device or combination of processing devices.

At block 151, an initial departure time is determined. The initial departure time may be the current time or a scheduled or desired departure time.

At block 152, a route score is calculated for each available alternative route. The route score is calculated based on conditions at the initial departure time. For example, the route score is calculated based on the position and routes of road treatment vehicles and conditions of each road segment along a route.

At block 153, the route scores are compared to a threshold. At block 154, if any of the alternative routes are greater than the threshold, the initial departure time is selected.

At block 155, if none of the alternative routes is suitable (i.e., no routes have both a route score that exceeds the threshold and will arrive at an acceptable arrival time), an amount of time is added to the initial time (e.g., 5 minutes, 30 minutes, one hour, etc.) and the route scores are recalculated. This process is iterated until a suitable departure time is determined.

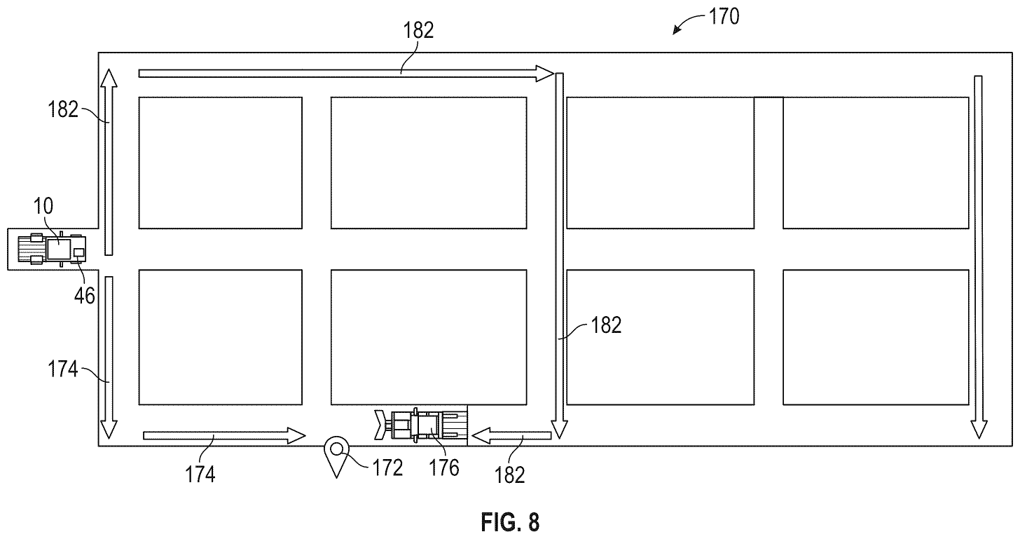

FIGS. 7 and 8 depict examples of performing one or more of the methods discussed herein. In these examples, the vehicle 10 is at an initial location at an initial time, and a driver wishes to travel within a road network 170 to an initial destination 172 (a grocery store). All or a subset of the road network is in a region in which it is currently snowing.

In both examples, the vehicle 10 is assigned an initial route 174. Also in both examples, a current position (position at the initial time) of a road treatment vehicle 176 (e.g., a snowplow 176) is shown.

In the example of FIG. 7, the vehicle 10 is a sedan, and thus does not have capability to traverse road segments on which snow has significantly accumulated. In the region of the initial route 174, it is currently snowing and the segments followed by the initial route 174 have not yet been plowed. Accordingly, the route score is relatively low and the planning module 46 determines that the initial route 174 is not suitable.

As there are no other suitable routes to the destination 172, the planning module 46 suggests an alternative destination 178 (another grocery store). The alternative destination 178 is accessible by an alternative route 180 that has a higher route score. Although the route 180 is not the shortest possible route, the route 180 has the highest score due to the relatively low capability of the vehicle 10, and the fact that the route 180 was very recently plowed. For example, other road segments are either not yet plowed or were plowed long enough in the past such that snow has accumulated to a point that the vehicle 10 should avoid the other road segments.

In the example of FIG. 8, the vehicle 10 is a four wheel drive truck, which has a higher capability. The vehicle 10 in this example can effectively travel on road segments that were plowed earlier and therefore have greater accumulation at the initial time, as compared to the example of FIG. 7. Accordingly, the threshold score for the vehicle 10 is higher in this example.

The planning module 46 is able to find a suitable route 182 to the initial destination 172. As shown, although the vehicle 10 could follow road segments that were more recently plowed by the snowplow 176, the route 182 is selected because this route is shorter and the vehicle 10 has a greater tolerance for snow accumulation (the route 180 includes a segment that was plowed thirty minutes ago and therefore has snow accumulation).

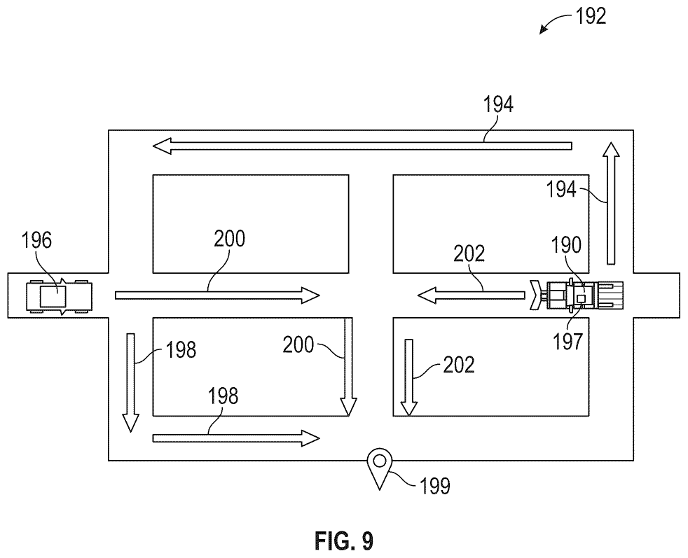

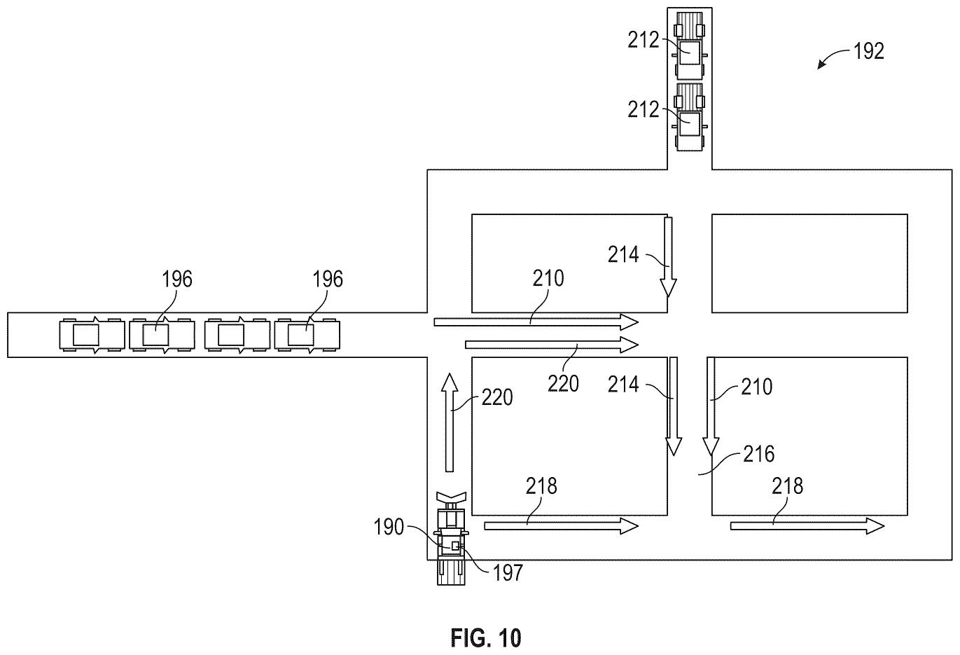

FIGS. 9 and 10 depict examples in which a road treatment vehicle updates or adjusts its own plowing route based on the location and route of one or more vehicles in the road network. In these examples, a snowplow 190 is located at an initial position in a road network 192. The snowplow 190 has an initial planned route 194, which may have been determined by a planning module 197 (e.g., in coordination with the control center 64, FIG. 1).

Referring to FIG. 9, a sedan 196 is travelling to a grocery store 172, and has an initial planned route 198 to a destination 199. A recommended route 200 for the sedan 196 is determined as described herein, and route information is sent to the snowplow 190 (or to a fleet management center or other entity responsible for coordinating with the snowplow 190). The snowplow 190, in response, updates its route (updated route 202) to prioritize plowing road segments to maximize the amount of plowed road for the sedan 196 to traverse.

The vehicle 196 may communicate with the snowplow 190 to determine the snowplow's route, and adjust its own travel accordingly. For example, the vehicle 196 may delay its planned departure time to follow the snowplow 190.

FIG. 10 depicts an example of a road treatment vehicle adjusting a plowing route based on a number and type of vehicle that are traversing, or planning to traverse, a road network. In this example, a plurality of sedans 196 are planning to travel along a planned route 210. In addition, a plurality of trucks 212 are planning to travel along a planned route 214. At the current time, a road segment 216 has been plowed very recently (e.g., a few seconds or minutes ago) and the remaining segments are unplowed.

The snowplow 190 has an initial planned route 218. Information regarding the sedans 196 and trucks 212 (e.g., initial locations, planned routes, capabilities, etc.) are provided to the snowplow 190, which prioritizes the needs based on vehicle type. In this example, an updated route 220 for the snowplow is calculated so that the route of the sedans 196 is plowed first. It is noted that other factors may be considered when prioritizing, such as the number of vehicles planning to traverse a given road segment or path.

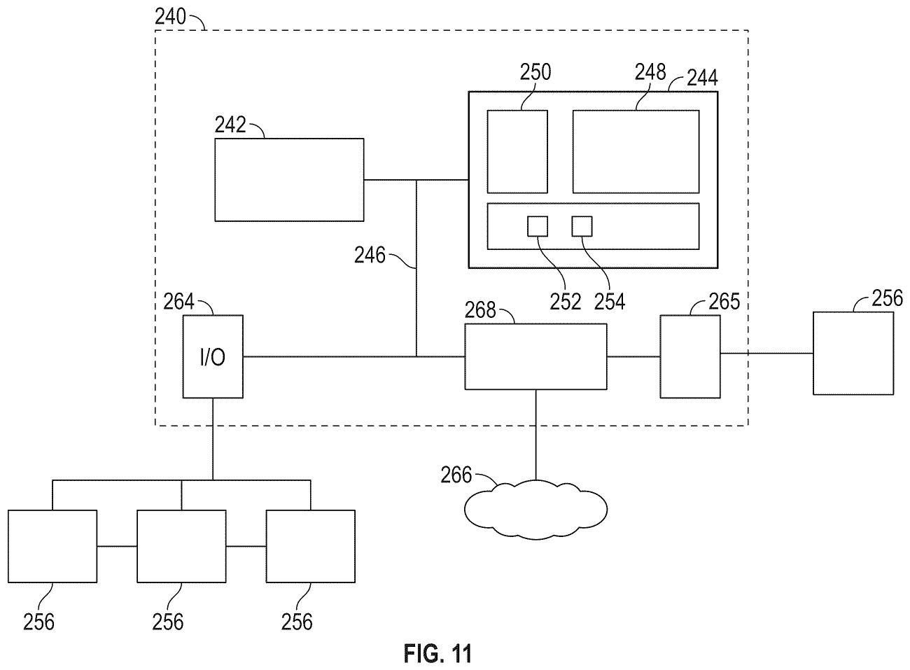

FIG. 11 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 250 may be included for performing functions related to acquiring data, and a module 252 may be included to perform functions related to planning vehicle routes as discussed herein. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for planning a route for a vehicle, comprising:
a route planning module configured to receive a destination, the route planning module configured to perform:
detecting that a road network in a geographic region is subject to a hazardous event that causes a hazardous condition in the road network;
identifying a subset of the road network that has been treated or will be treated within a selected time window to remediate the hazardous condition; and
calculating a planned route for the vehicle to follow based on the destination and the identified subset of the road network; and
a second module configured to perform at least one of controlling the vehicle to follow the planned route, and presenting the planned route to a vehicle user.

2. The system of claim 1, wherein the subset of the road network is identified based on tracking data indicative of a position and movement of road treatment vehicles in the geographic region.

3. The system of claim 1, wherein the subset of the road network is identified based on an evaluation of current weather conditions and historical data related to past road treatments.

4. The system of claim 1, wherein the planned route terminates at the destination.

5. The system of claim 1, wherein calculating the planned route includes updating an initial route determined for the vehicle, the initial route terminating at an initial planned destination.

6. The system of claim 5, wherein updating the initial route includes selecting a new destination based on determining that the initial planned destination is not feasible given a capability of the vehicle.

7. The system of claim 1, wherein calculating the planned route is based on a capability of the vehicle to travel on a road segment having the hazardous condition.

8. The system of claim 1, wherein the vehicle is a road treatment vehicle, and the planned route is calculated to cause the road treatment vehicle to follow a treatment path based on a traffic flow of one or more other vehicles in the geographic region.

9. The system of claim 7, wherein the planned route is calculated based on a destination and vehicle type associated with each of a plurality of other vehicles traversing the road network.

10. A method of planning a route for a vehicle, comprising:
receiving a destination;
detecting that a road network in a geographic region is subject to a hazardous event that causes a hazardous condition in the road network;
identifying a subset of the road network that has been treated or will be treated within a selected time window to remediate the hazardous condition;
calculating a planned route for the vehicle to follow based on the destination and the identified subset of the road network; and
performing at least one of controlling the vehicle to follow the planned route, and presenting the planned route to a vehicle user.

11. The method of claim 10, wherein the subset of the road network is identified based on tracking data indicative of a position and movement of road treatment vehicles in the geographic region.

12. The method of claim 10, wherein the subset of the road network is identified based on an evaluation of current weather conditions and historical data related to past road treatments.

13. The method of claim 10, wherein calculating the planned route includes updating an initial route determined for the vehicle, the initial route terminating at an initial planned destination or terminating at a new destination based on determining that the initial planned destination is not feasible given a capability of the vehicle.

14. The method of claim 10, wherein calculating the planned route is based on a capability of the vehicle to travel on road segments having the hazardous condition.

15. The method of claim 10, wherein the vehicle is a road treatment vehicle, and the planned route is calculated to cause the road treatment vehicle to follow a treatment path based on a traffic flow of one or more other vehicles in the geographic region.

16. A vehicle system comprising:
a memory having computer readable instructions; and
a processing device for executing the computer readable instructions, the computer readable instructions controlling the processing device to perform a method including:
receiving a destination and a request to determine a route to the destination for a vehicle to traverse;
detecting that a road network in a geographic region is subject to a hazardous event that causes a hazardous condition in the road network;
identifying a subset of the road network that has been treated or will be treated within a selected time window to remediate the hazardous condition;
calculating a planned route for the vehicle to follow based on the destination and the identified subset of the road network; and
performing at least one of: controlling the vehicle to follow the planned route, and presenting the planned route to a vehicle user.

17. The vehicle system of claim 16, wherein the subset of the road network is identified based on tracking data indicative of a position and movement of road treatment vehicles in the geographic region.

18. The vehicle system of claim 16, wherein the subset of the road network is identified based on an evaluation of current weather conditions and historical data related to past road treatments.

19. The vehicle system of claim 16, wherein calculating the planned route includes updating an initial route determined for the vehicle, the initial route terminating at an initial planned destination or terminating at a new destination based on determining that the initial planned destination is not feasible given a capability of the vehicle, and wherein calculating the planned route is based on a capability of the vehicle to travel on a road segment having the hazardous condition.

20. The vehicle system of claim 16, wherein the vehicle is a road treatment vehicle, and the planned route is calculated to cause the road treatment vehicle to follow a treatment path based on a traffic flow of one or more other vehicles in the geographic region.
